(19) United States
(12) Patent Application Publication
(10) Pub. No.: US 2020/0357214 A1
(43) Pub. Date: Nov. 12, 2020

(54) MANAGING AND CONTROLLING ACCESS TO SECURED AREAS

(71) Applicant: Jonathan Aaron HARWELL, Trussville, AL (US)

(72) Inventor: Jonathan Aaron HARWELL, Trussville, AL (US)

(21) Appl. No.: 16/869,151

(22) Filed: May 7, 2020

Related U.S. Application Data
(60) Provisional application No. 62/844,343, filed on May 7, 2019.

(51) Int. Cl. G07C 9/33

(52) U.S. Cl. CPC G07C 9/33

(57) ABSTRACT

A method for updating a keypad code for an entry control system includes a step of providing a first code to a client system via a network. The method also includes a step of capturing the first code from the client system when the system is brought into proximity of an entry control system via a local connection to the entry control system. The method also includes a step of comparing the first code with a second code, the second code being a predetermined code previously provided to the entry control system. The method also includes a step of updating a keypad code associated with an authorized user for a keypad provided in communication with the entry control system. When the keypad code is entered on a keypad, the entry control system grants access to a secured area.

### RELATED APPLICATIONS

This application claimed the benefit of U.S. Provisional Application No. 62/844,343, filed May 7, 2019, the entire disclosures of which are incorporated herein by this reference.

### TECHNICAL FIELD

Exemplary embodiments of the present invention relate to access control management for enclosed areas that are secured at access points to the enclosed areas. More specifically, exemplary embodiments relate to access control environments utilize portable user devices, entry control systems at the access points for controlling access to the enclosed areas, and remote access management systems for managing access privileges for the enclosed areas.

### BACKGROUND

Access control systems are commonly used to limit access to enclosed areas such as residential and commercial premises, fenced-in regions, and buildings to only persons who have been granted permission to enter. In such systems, physical access to the enclosed area is secured by placing a movable barrier that is moved between open and closed positions by an electric motor and controlled by installing an entry control system that operates to generate control signals for unlocking and/or moving the barrier to an open position, thereby permitting access to the secured area. Upon being unlocked or moved to an open position, the barrier typically remains open for a specified amount of time. Such a movable barrier may be a gate, a door, or the like, and may be constructed as an access point to a secured area within a fence or a wall that encloses the secured area.

In various conventional systems, the control signal for opening the barrier and thereby providing access to the enclosed area secured by the barrier may be generated in response to a coded input entered on a keypad adjacent the barrier by an authorized person who has been provided with the code, an input at the secured area or proximate to the barrier by a person wishing to provide access to a visitor at the barrier who has been identified through a communication system linking the barrier and the premises, or an access card reader adjacent to the barrier reading information from access control card that has been provided to and is carried by an authorized person and communicating the information read from the card to a control unit that determines that the barrier should be opened (that is, the card is associated with a person who has permission to enter).

In a more sophisticated implementation, such an access control system can utilize a wide area or cellular network connection with a remote management system for performing authentication of a person wishing to access a secured area to determine whether access credentials provided by the person to the entry control system indicate that the person is authorized, although such implementations typically require the entry control system to be continuously coupled to the remote management system over a secure communication channel via the network for validating access privileges for persons wishing to access the secured area.

However, current systems typically require connectivity between an access control point and a central server that provides access information for authorized users. In numerous situations, connectivity may not be available or practical. As an example, for remote communities, such as camping or hunting lodges, cellular, wifi, or hardline access may not be present or economically feasible to install. In addition, even when such access is possible, access systems may require a physical power line to ensure that the cellular, wifi, or hardline access provides the connectivity to the central server system.

While physical locks are possible to use in such instances, such systems may be less secure, do not provide traceability with respect to logging of authorized users who access a secure area protected by an access control system, and physical locks cannot provide the added security associated with dynamic code generation. In addition, physical locks are not convenient if in a remote location if a temporary visitor or vendor requires access as a physical key is typically required which may be an inconvenient or less secure option.

Likewise, locks controlled by physical or electronic keypads lack the ability to be updated in remote areas with the intervention of a technician which can be costly and inconvenient, particularly if only required on temporary or sporadic basis when a vendor or temporary visitor needs access to a particular secured area.

The inventions described herein overcomes the disadvantages of the above described conventional technologies used to control access to secure areas.

### SUMMARY

Exemplary embodiments of the present invention are related to methods for managing and controlling access to secured areas. Some exemplary implementations of the method comprise providing a first code to a client system via a network, the first code being stored in an application resident on the client system; capturing the first code from the client system when the client system is brought into proximity of an entry control system via a local connection to the entry control system; comparing the first code with a second code, the second code being a predetermined code previously provided to the entry control system; and granting access to a secured area if the first code and second code match.

Some exemplary implementations of the method further comprise providing multiple additional codes and each of the multiple additional codes are captured from the client system when the client system is brought into proximity of the entry control system. In some embodiments, the multiple additional codes are captured from the client system if the first code and second code match. In some embodiments, the first and second codes are associated with a first authorized user and one of the multiple additional codes is associated with a second authorized user.

In some embodiments, the entry control system is previously provided with a list of predetermined codes that correspond to the multiple additional codes.

In some embodiments, one of the multiple additional codes is a first verification code which is compared to a second verification code previously provided to the entry control system. Access is granted to the secured area if both (1) the first code and second code match and (2) the first verification code and the second verification code match. In some embodiments, the first and second codes are associated with one of multiple authorized users and the first and second verification codes are associated with one of multiple entry control systems.

In some embodiments, the first code, the second code, or both the first code and the second code include information about a predetermined time interval in which to grant access to the secured area and access is granted to the secured area if (1) the first code and second code match and (2) the first code is captured during the predetermined time internal.

In some embodiments, the client system is additionally provided a future access code and the future access code is captured from the client system when the client system is brought into proximity of the entry control system. In such embodiment, the exemplary implementation of the method further comprises providing an access code to a second client system via the network, the access code being stored in an application resident on the second client system; capturing the access code from the second client system when the second client system is brought into proximity of the entry control system via the local connection to the entry control system; comparing the access code with the future access code previously provided to the entry control system; and granting access to the secured area if the access code and future access code match.

In some embodiments, the first code is a pseudorandom code generated on the client system and wherein the second code is a pseudorandom code generated on the entry control system.

In some embodiments, the second code is a hard wired to the entry control system.

In some embodiments, the local connection provides for bidirectional data flow between the client system and the entry control system. In such embodiment, some exemplary implementations of the method further comprises capturing status information about the entry control system from the entry control system when the client system is brought into proximity of the entry control system via the local connection.

Some exemplary implementations of the method further comprise establishing a connection between the client system and a remote access management system via the network, the remote access management system providing the first code to the client system.

Some exemplary implementations of the method further comprise capturing status information about the entry control system from the entry control system when the client system is brought into proximity of the entry control system via the local connection and providing the status information to the remote access management system.

Exemplary embodiments of the present invention are related to methods for updating a keypad code for an entry control system. Some exemplary implementations of the method comprise providing a first code to a client system via a network; capturing the first code from the client system when the client system is brought into proximity of an entry control system via a local connection to the entry control system; comparing the first code with a second code, the second code being a predetermined code previously provided to the entry control system; and updating a keypad code associated with an authorized user for a keypad provided in communication with the entry control system. When the keypad code is entered on the keypad, the entry control system grants access to a secured area.

In some embodiments, an application resident is provided on the client system and the first code is stored in the application.

Some exemplary implementations of the method further comprise verifying the keypad code based on a predetermined code stored on the entry control system and updating the keypad code if verified.

Exemplary embodiments of the present invention that are related to data processing systems and computer program products corresponding to the above-summarized method are also described and claimed herein.

The above-described and other features and advantages realized through the techniques of the present disclosure will be better appreciated and understood with reference to the following detailed description, drawings, and appended claims. Additional features and advantages are realized through the techniques of the present invention. Other embodiments and aspects of the invention are described in detail herein and are considered a part of the claimed invention.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description of exemplary embodiments of the present invention taken in conjunction with the accompanying drawings in which:

FIG. 1 illustrates a system consistent with the exemplary embodiments described herein;

FIG. 2 illustrates a system consistent with the exemplary embodiments described herein;

FIG. 3 illustrates a system consistent with the exemplary embodiments described herein;

FIG. 4 illustrates a flowchart consistent with the exemplary embodiments described herein;

FIG. 5 illustrates a flowchart consistent with the exemplary embodiments described herein;

FIG. 6 is a block diagram of an exemplary computer system that can be used for implementing exemplary embodiments described herein;

FIG. 7 illustrates a system consistent with the exemplary embodiments described herein; and

FIG. 8 illustrates a system consistent with the exemplary embodiments described herein.

The detailed description explains exemplary embodiments of the present invention, together with advantages and features, by way of example with reference to the drawings, in which similar numbers refer to similar parts throughout the drawings. The flow diagrams depicted herein are just examples. There may be many variations to these diagrams or the steps (or operations) described therein without departing from the spirit of the invention. For instance, the steps may be performed in a differing order, or steps may be added, deleted, or modified. All of these variations are considered to be within the scope of the claimed invention.

### DESCRIPTION OF EXEMPLARY EMBODIMENTS

While the specification concludes with claims defining the features of the invention that are regarded as novel, it is believed that the invention will be better understood from a consideration of the description of exemplary embodiments in conjunction with drawings. It is of course to be understood that the embodiments described herein are merely exemplary of the invention, which can be embodied in various forms. Therefore, specific structural and functional details disclosed in relation to the exemplary embodiments described herein are not to be interpreted as limiting, but merely as a representative basis for teaching one skilled in the art to variously employ the present invention in virtually any appropriate form, and it will be apparent to those skilled in the art that the present invention may be practiced without these specific details. Further, the terms and phrases used herein are not intended to be limiting but rather to provide an understandable description of the invention.

Exemplary embodiments of remote access control systems in accordance with the present invention will now be described with reference to the drawings.

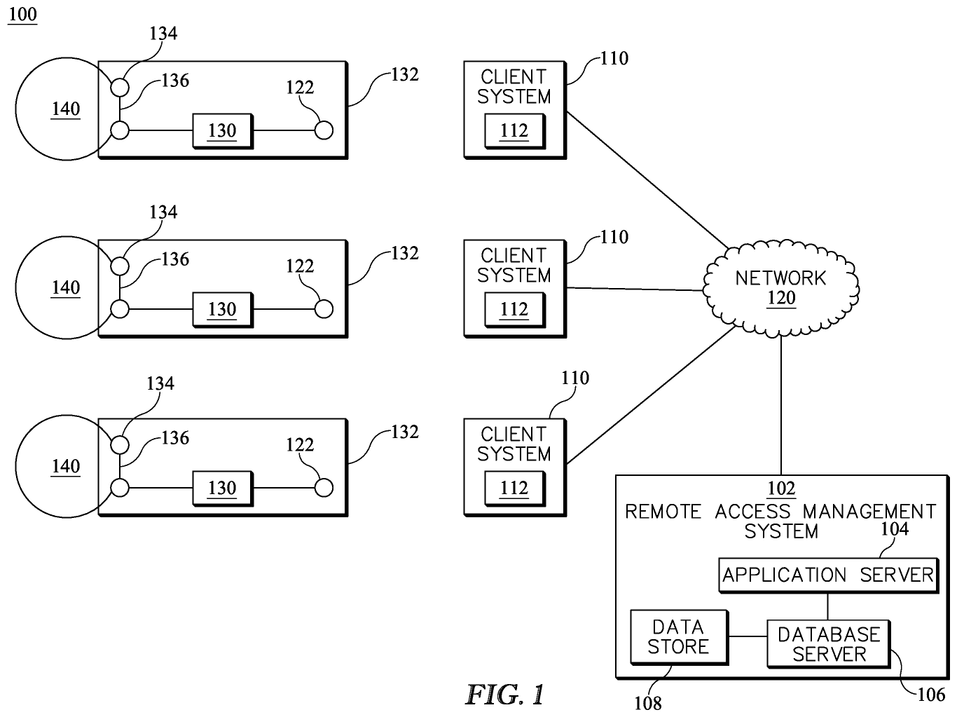

Referring now to FIG. 1, a schematic diagram illustrating an example network architecture within which exemplary embodiments of the present invention can be implemented is illustrated. It should of course be understood that FIG. 1 is provided as an example, not as an architectural or environmental limitation for different embodiments of the present invention, and therefore, the particular elements depicted in FIG. 1 should not be considered limiting with regard to the environments within which exemplary embodiments of the present invention may be implemented.

In the example architecture depicted in FIG. 1, an access control environment 100 is provided as a client/server environment that includes a remote access management system 102 that is commonly accessed by each user of the system through operation of any of a plurality of portable user, or client, systems 110 that are configured to operatively couple to the remote access management system via a communication network 120.

Exemplary access control environment 100 of FIG. 1 further includes a plurality of access points 130 for respectively controlling access to a plurality of secured areas 140. In exemplary embodiments, each access point 130 includes an entry control system 132 comprising one or more wireless devices capable of receiving wireless signals from client systems 110 and communicating with a locking mechanism 134, which, in some embodiments, comprise a device that is communicatively coupled to the entry control system and capable of locking and/or controlling access to the corresponding secured area for the access point. A physical barrier 136 is connected to locking mechanism 134 and such that, when locking mechanism 134 frees the lock securing the barrier 136, the barrier is able to be opened. In the example architecture illustrated in FIG. 1, each of the access points 130 includes a local connection 122 and the client systems 110 are further configured to communicate with a respective access point 130 by establishing a communication channel with the respective local connection 122, as discussed further below.

In the example architecture illustrated in FIG. 1, the remote access management system 102 includes an application server 104 and a database server 106 that is coupled to a data store 108. Each of the application server 104 and the database server 106 are operatively coupled to network 120. As will be described in greater detail herein, the application server 104 may be implemented to manage access information maintained in the data store 108 by the database server 106 for each respective area secured by the access points 130 and communicate, via the network 120, with client systems 110, which, as noted above, are also configured to connect to the network 120. The application server 104 may therefore comprise, for example, one or more server computers with high speed connections to the network 120.

In exemplary embodiments, each client system 110 is a portable user terminal or other portable client device configured to access services provided within the remote access management system 102 via a network-based application (also referred to herein as a network service) implemented by the application server 104. For example, client systems may be implemented with software for one or more corresponding client applications that may be executed on the client system to allow users to interact with the application server 104 to access services provided within the remote access management system 102. Such client applications may also be referred to as client modules, or simply clients, and may be implemented in a variety of ways. In exemplary embodiments, such client applications can be implemented as any of a myriad of suitable client application types, which range from proprietary client applications (thick clients) to web-based interfaces in which the user agent function is provided by a web server and/or a back-end program (for example, a CGI program).

In some exemplary embodiments, the access control environment 100 includes additional servers, clients, and other devices not shown in FIG. 1. The particular architecture depicted in FIG. 1 is provided as an example for illustrative purposes and, in exemplary embodiments, any number of client systems may be connected to any number of different servers within the remote access management system 102 at any given time via the network 120, and the remote access management system 102 can comprise multiple server components and data stores located within a single server system or within multiple server systems, where the multiple server systems are integrated with or accessible by users of the client systems 110 as a distributed server system via the network 120. In exemplary embodiments, the remote access management system 102 may also include at least one third-party server system, which may be utilized to enable functionality that may be accessed and utilized by the application server 104 to provide and/or enhance the access management services discussed herein.

In some exemplary embodiments, the network 120 can be configured to facilitate networked communications between the management system 102 and client systems 110, as well as communications with and between other devices and computer systems coupled together within the access control environment 100, by any suitable wired (including optical fiber), wireless technology, or any suitable combination thereof, including, but not limited to, personal area networks (PANs), local area networks (LANs), wireless networks, wide-area networks (WAN), the Internet (a network of heterogeneous networks using the Internet Protocol, IP), and virtual private networks, and the network may also utilize any suitable hardware, software, and firmware technology to connect devices such as, for example, optical fiber, Ethernet, ISDN (Integrated Services Digital Network), T-1 or T-3 link, FDDI (Fiber Distributed Data Network), cable or wireless LMDS network, Wireless LAN, Wireless PAN (for example, IrDA, Bluetooth, Wireless USB, Z-Wave and ZigBee), HomePNA, Power line communication, or telephone line network. Such a network connection can include intranets, extranets, and the Internet, may contain any number of network infrastructure elements including routers, switches, gateways, etc., can comprise a circuit switched network, such as the Public Service Telephone Network (PSTN), a packet switched network, such as the global Internet, a private WAN or LAN, a telecommunications network, a broadcast network, or a point-to-point network, and may utilize a variety of networking protocols now available or later developed including, but not limited to the Transmission Control Protocol/Internet Protocol (TCP/IP) suite of protocols for communication.

In exemplary embodiments, the application server 104, the database server 106, and any other servers employed within the management system 102 and third-party servers utilized within the access control environment 100 can be implemented within any suitable computing system or systems such as a workstation computer, a mainframe computer, a server system (for example, SUN ULTRA workstations running the SUN operating system, IBM RS/6000 workstations and servers running the AIX operating system, or an IBM zSeries eServer running z/OS, z/VM, or LINUX OS), a server cluster, a distributed computing system, a cloud based computing system, or the like, as well as any of the various types of computing systems and devices described below with reference to the client systems 110. Management system 102 may be implemented using any of a variety of architectures. For example, the application server 104 and the database server 106 may also be implemented independently or as a single, integrated device. While the exemplary embodiment illustrated in FIG. 1 depicts the application server 104 and the database server 106 as individual components, the applications provided by these servers, or various combinations of these applications, may actually be server applications running on separate physical devices. In this regard, the management system 102 may comprise a number of computers connected together via a network and, therefore, may exist as multiple separate logical and/or physical units, and/or as multiple servers acting in concert or independently, wherein each server may be comprised of multiple separate logical and/or physical units. In exemplary embodiments, management system 102 can be connected to the network 120 through a collection of suitable security appliances, which may be implemented in hardware, software, or a combination of hardware and software.

In the exemplary architecture illustrated in FIG. 1, the application server 104 is communicatively coupled to the database server 106. The database server 106 is connected to the data store 108, which is implemented as a network storage device capable of storing data in a structured or in an unstructured format. In exemplary embodiments, the data store 108 may comprise a plurality of databases that are maintained by the database server 106, accessed by the application server 104 via database services provided at a front end by the database server 106, and store data representing a variety of information that is utilized in providing the access management services offered via the network service provided by the application server 104, as described in greater detail below.

As used herein, the term “data store,” “data storage unit,” storage device”, and the like can to any suitable memory device that may be used for storing data, including manual files, machine-readable files, and databases. In exemplary embodiments, the application server 104, the database server 106, and the data store 108 may implemented together a single computing device, implemented within a plurality of computing devices locally coupled to each other via a suitable communication medium, such as a serial port cable, telephone line, or wireless frequency transceiver, implemented within a plurality of computing devices remotely coupled to each other via the network 120, or any suitable combination thereof.

The portable client systems 110 are computer devices to which one or more users have access and that are also configured to connect to the network 120 and may access remote access management system 102 via the network 120 to operate as clients to the remote access management system 102. In exemplary embodiments, the client systems 110 are each further configured to establish a communication channel with and thereby communicate with one or more of access points 130 using the respective local connection 122 for the access point. It should be noted that the term “user” is used herein to refer to one who uses a computer system, such as one of the client systems 110. As described in greater detail below, client systems 110 are each operable by such users to access management system 102 via network 120 and act as clients to access services offered by the network service provided by the server system within the access control environment 100. For this purpose, as noted above, each client system 110 includes a respective client application 112 that executes on the client system 110 and allows a user to interact with the management system 102 via the application server 104.

Client systems 110 can represent any type of portable device capable of communicating with the application server 104 and access points 130. While client systems 110 are depicted in FIG. 1 as a single device, such depiction is for illustrative purposes only, and each of the client systems can represent a single portable device or a plurality of portable devices capable of communicating with the application server 104 and access points 130.

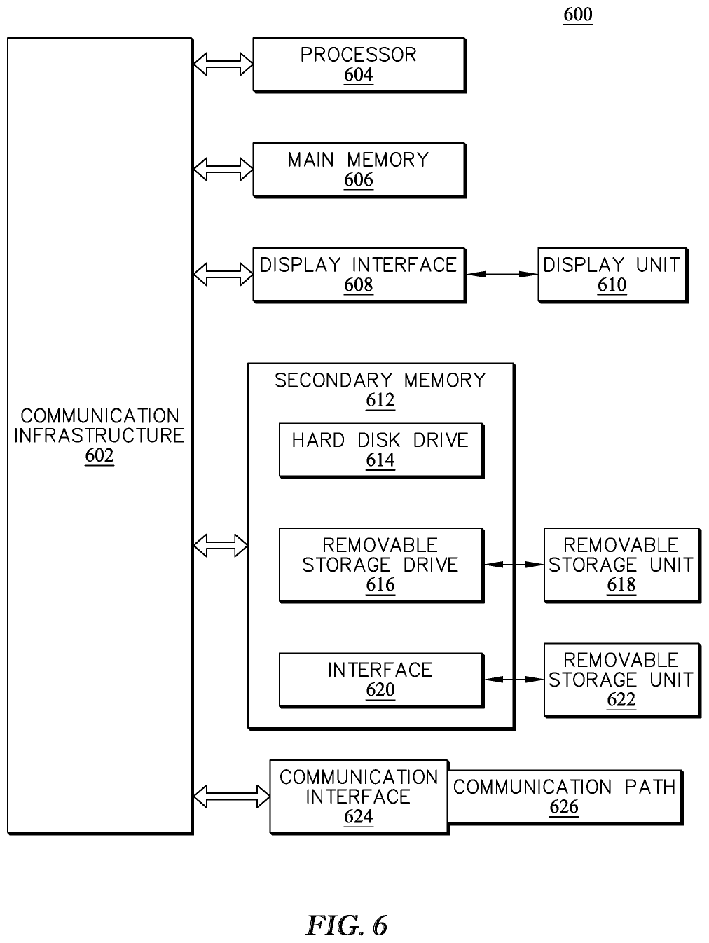

In exemplary embodiments, the computer systems of client systems 110 can be any of a wide range of suitable portable or handheld computing devices such as one or more handheld computers, laptops, tablet computers, netbook computers, two-way pagers, cellular telephones, mobile handsets, smart phones, computer digital devices such as Personal Digital Assistants (PDAs), and the like, or any other suitable portable or handheld information processing devices. In general exemplary embodiments, a portable or handheld electronic device that is utilized as a client system 110 within access control environment 100 may comprise a small general computing device having a processing unit that is capable of running one or more application programs, a display, an input mechanism that is typically something other than a full-size keyboard and wireless communication capability. The input mechanism may be, for example, a keypad, a touch-sensitive screen, a track ball, a touch-sensitive pad, a miniaturized QWERTY keyboard, or the like. An exemplary computer system for client systems 110 is described in greater detail below with reference to FIG. 6.

In general, during operation within the exemplary access control environment 100, a client system 110 first establishes a connection to the remote access management system 102 via network 120. Once the connection has been established, the connected client system 110 may directly or indirectly transmit data to and access content from the application server 104. A user accessing the application server 104 through the connected client system 110 can thereby to use the client application 112 to access services provided by the application server 104, which are described in greater detail below, via a user interface implemented by the client application 112 within which the client application 112 renders the information served by the application server 104.

In exemplary embodiments, the application server 104 can implement the network service as a non-web client application (such as a mobile application), a web client application, or both to provide the services accessed by client systems 110 within the management system 102, and client applications 112 can correspondingly be implemented as non-web client applications, web client applications, or both for operation by users of the client systems 110 to interact with the application server 104 and access the services provided thereby. For example, the application server 104 can comprise a web server configured to provide a web application for the respective client applications implemented on client systems 110 that are configured to provide web-based user interfaces for utilizing the services provided by the web server. For instance, the user interfaces of client applications implemented on client systems 110 can be configured to provide various options corresponding to the functionality offered in exemplary embodiments described herein through suitable user interface controls (for example, by way of menu selection, point-and-click, dialog box, or keyboard command). In one general example, the user interfaces may provide “send” or “submit” buttons that allow users of client applications to transmit requested information to application server 104. The user interfaces can be implemented, for example, as a graphical user interface (GUI) that renders a common display structure to represent the network service provided by application server 104 for a user of a client platform.

In exemplary embodiments, client applications 112 and the application server 104 may be configured to utilize cryptographic protocols so that communications and information exchanged between the management system 102 and the client systems 110 can be encrypted and decrypted using one or more encryption methods and sent over a secure network connection for purposes of, for example, preventing unauthorized access to management system 102 and privacy.

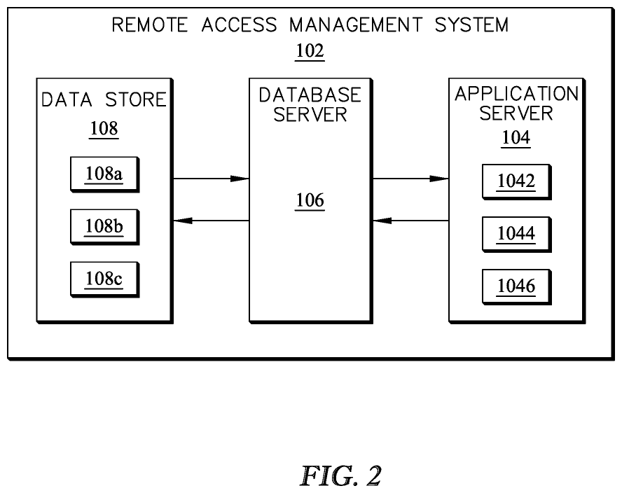

Referring now to FIG. 2, a block diagram illustrating an exemplary embodiment of a remote access management system 102 is provided. As illustrated in FIG. 2, an application server 104 is implemented to provide a plurality of services, including an account management service 1042, a secured area management service 1044, and a secured area access service 1046.

In exemplary embodiments, the application server 104 can implement the services offered thereby to provide a respective set of functionality for each of various types of users (for example, property owners, property managers, property staff, residential tenants, commercial tenants, guests, and the like). Some of the functionality offered by the application server 104 can be commonly applicable to and accessible by all types of users, while other functionality can be applicable to and accessible only by specific types of users. In addition, a particular user account can have any number of authorized users. As an example, a user account established for a property manager can have the property manager as one of its users, but it can also have staff working for the property manager as other authorized users. For purpose of illustration, there can be a designated user (for example, an account administrator) who is responsible for managing the account. The administrator can be provided with greater access rights within management system 102 with respect to the account. In exemplary embodiments, the particular client applications 112 or the particular client systems 110 (shown in FIG. 1) that are utilized for accessing application server 104 can be respective to and customized for each type of user account. For example, the particular client application 112 that is utilized for each type of account can implement a platform that is specific to the functionality offered for that type of account.

As further illustrated in exemplary embodiment of FIG. 2, and as will also be described in greater detail below, a data store 108 comprises a plurality of databases that are maintained and accessible by the application server 104 via a database server 106, including a user profile database 108a, a secured area database 108b, and one or more additional databases 108c that may be used for storing any other suitable information that may be utilized by the management system 102 (for example, system usage data, audit trail data, data used internally within the system by application server 104, and the like). In exemplary embodiments, the various databases maintained within the data store 108 can be maintained as groups within one or more larger databases or maintained individually.

As discussed below, the database server 106 can be configured to maintain various types of information records within the plurality of databases. An information record may be, for example, a program and/or data structure that tracks various data related to a corresponding type of information record. As used herein, the terms “data,” “content,” “information” and similar terms may be used interchangeably to refer to data capable of being captured, transmitted, received, displayed, and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like. Similarly, where a computing device is described herein to send data to another computing device, it will be appreciated that the data may be sent directly to the another computing device or may be sent indirectly via one or more intermediary computing devices, such as, for example, one or more servers, relays, routers, network access points, base stations, and/or the like.

As noted above, different types of users can access the remote access management system 102. As such, the application server 104 can be configured to maintain and manage account information records for different types of users that register with the system according to certain categories of accounts. In the present exemplary embodiment, the user profile database 108a is used to maintain account information records for secured area managers that are registered with the management system 102 to grant access privileges for one or more secured areas to secured area entrees registered with the system and, likewise, for secured area entrees that are registered with the management system 102 to receive access credentials in accordance with access privileges granted by secured area managers registered with the system.

For each user for which a user account is registered with the management system 102, various items of information relevant to the user, such as name, address or location information, contact information, billing information, unique identification information for one or more client systems 110 utilized by the user, such as an International Mobile Subscriber Identity (IMSI) number associated with the subscriber identity module (SIM) card of mobile device, and any other suitable identifying information, as well as a unique user name and password associated with the account that can be used to log into the account, can be included in the respective account information record for the user that is maintained within the user profile database 108a. The account information record for each user can also be associated with a unique user account identifier within the user profile database 108a that is used by the application server 104 for performing various operations.

For each secured area manager user for which an account is registered and maintained within the user profile database 108a, various additional items of information relevant to the secured area manager may also be included in the respective account information record for the user that is maintained within the user profile database 108a, such as unique secured area identifiers for the particular secured areas within the access control environment 100 for which the secured area manager has rights to grant access privileges, unique user account identifiers for secured area entree users of the management system 102 for which the secured area manager can grant access privileges for secured areas for which the secured area manager has rights to grant access privileges, and a list of access privileges that the secured area manager has granted for secured area grantee users with respect to secured areas for which the secured area manager has rights to grant access privileges. In exemplary embodiments, the list of access privileges that are maintained within the respective account information record for each secured area manager that is maintained within the user profile database 108a can include an indication of whether each access privilege is currently active or inactive or, alternatively, can only include access privileges that are currently active.

For each secured area entree user for which an account is registered and maintained within the user profile database 108a, various additional items of information relevant to the secured area manager may also be included in the respective account information record for the user that is maintained within the user profile database 108a, such as unique user account identifiers for the secured area manager users of that management system 102 that can grant access privileges for secured areas within the access control environment 100, unique secured area identifiers for secured areas for which the secured area entree user can be granted access privileges, a list of access privileges for secured areas that have been granted to the secured area entree user by the secured area managers that are registered with the system, a set of access credential information that has been provided or is available to the secured area entree user for each secured area for which access privileges have been granted to the secured area entree user by secured area managers that are registered with the system, and user access history logs for the user pertaining to past user accesses of secured areas within the access control environment 100, which may include profiling of client system usage, client application usage, and application data; historical data about any of these items of information related to the client system 110 used by the user; and any other contextual information, available to or stored in the client system 110, in any combination.

In exemplary embodiments, the list of access privileges and the corresponding set of access credential information that are maintained within the respective account information record for each secured area entree user that is maintained within the user profile database 108a can include an indication of whether each access privilege or set of access credential information is currently active or inactive or, alternatively, can only include access privileges and/or access credential information that are currently active. In exemplary embodiments, access credentials can comprise, for instance, passwords, security codes, digital certificates, and the like. In further embodiments, access credentials can comprise computer readable and/or executable files that can be transferred to and stored on the client systems 110.

In the exemplary embodiment depicted in FIG. 2, the secured area database 108b is used to maintain information records for secured areas within the access control environment 100 that have been registered within the management system 102 for which access privileges can be granted to secured area entrees registered with the system by secured area managers registered with the system. For each secured area that has been registered with the management system 102, various items of information relevant to the secured area, such as area or property name, address or location information, information describing the corresponding access point 130 for the secured area, and any other suitable identifying information, as well as the unique user account identifier for each registered secured area manager that has rights to grant access privileges to registered secured area entrees for the secured area, the unique user account identifier for each registered secured area entree to which access privileges for the secured area can be granted by registered secured area entrees, a list of access privileges for the secured area that have been granted to registered secured area entree users by registered secured area managers, a set of access credential information that has been provided to each secured area entree user for which access privileges have been granted to the secured area by registered secured area managers, and one or more sets of additional access credential information that is available to be provided to secured area entree users for which access privileges have been granted to the secured area by registered secured area managers or upon access privileges being granted to secured area entree users for the secured area by registered secured area managers, can be included in the respective information record for the secured area that is maintained within secured area database 108b. The information record for each secured area can also be associated with a unique secured area identifier within the secured area database 108b that is used by the application server 104 for performing various operations.

In exemplary embodiments, and referring once again to FIG. 1 in addition to FIG. 2, a user of a client system 110 within the access control environment 100 may be required to first install a client application 112 on the client system 110 before the client system 110 can access the services provided by application server 104. For example, upon the user initiating the installation of the client application 112, the client system 110 can download the client application 112 from the remote access management system 102 or from a separate content server. Upon receipt of the client application 112, the client system 110 can operate to install the client application 112.

In exemplary embodiments, when any user, regardless of whether the user is registered with the management system 102 with any type of user account or a non-registered user, operates a client system 110 to access application server 104 (for example, by launching a native client application or by using a web browser to submit a URL that provides a network address for application server 104), the application server 104 can be configured with a default setting that directs the user to a home page within the user interface implemented by the application server 104 for the services provided by the application server 104, at which the user is presented with various options through the user interface to access the various functions that are provided by the account management service 1042, the secured area management service 1044, and/or the secured area access service 1046 and available to the particular user.

In such embodiments, a secured area entree user may be required to first register with the management system 102 and thereby establish a respective account information record within the user profile database 108a to be able to request and receive access credentials from the application server 104 via the secured area access service 1046. In exemplary embodiments, a user operating a client system 110 to access application server 104 via a corresponding client application 112 executing on the client system 110 may be provided with a user interface element within the user interface implemented by the application server 104 that is accessible by the user to initiate a registration with the management system 102 as a secured area entree user, and the application server 104 may be configured to, in response to a user accessing the user interface element, provide further user interface controls for allowing the user to initiate a registration session with the account management service 1042 to register a user account with the management system 102.

The account management service 1042 may be configured, for example, to implement a user interface that includes a series of pages with user interface controls accessible by the user to guide the user through the account registration process and prompt the user to input various types of information to be maintained by the database server 106 within a respective account information record that is established for the user within user profile database 108a. The account management service 1042 can be configured to access the database server 106 to create the respective account information record for the user within the user profile database 108a based on the information input by the user during the registration process. The account management service 1042 can be further configured to generate the unique customer account identifier for the created account information record, which may be used, for example, to index and reference the created account information record within the database server 106. The created account information record can also be identified with a unique user name and protected by a password, which can be used by the user to log into the associated user account when accessing the application server 104.

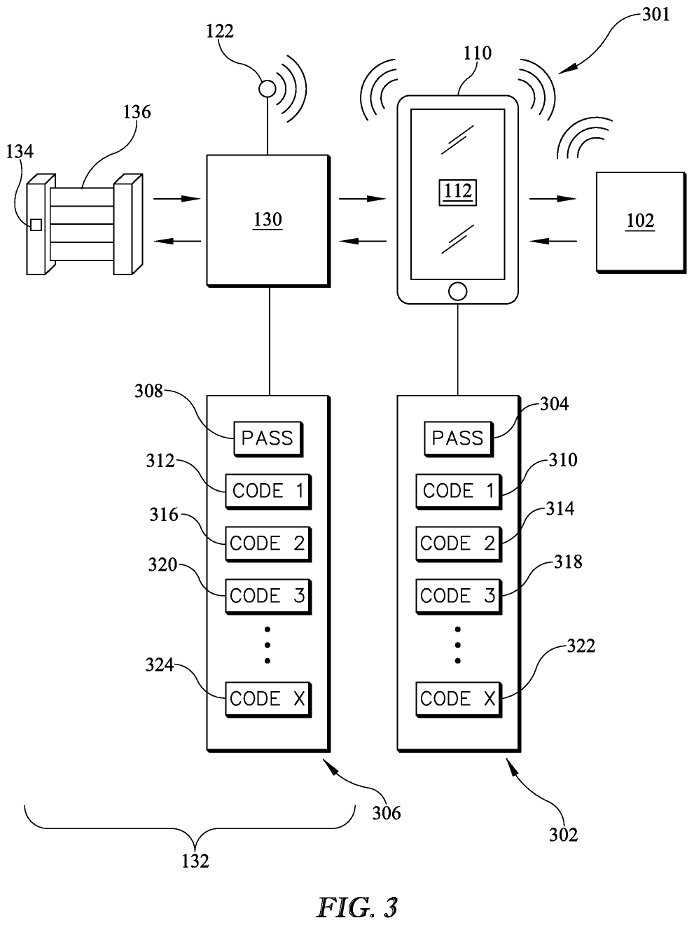

The system shown in FIG. 3 includes an exemplary embodiment of the system used in applications described herein. As illustrated in FIG. 3, a client system 110 is initially provided in communication with the remote access management system 102 via connection 301. A pass code 304 is a code authorizing a user to enter one or more of the secured areas 140 shown in FIG. 1 which is blocked by a physical barrier (e.g., gate) 136 with a locking mechanism 134 illustrated in FIG. 3. The pass code 304 is transferred from the remote access management system 102 to a memory 302 on client system 110. Transfer may take place using any number of methods including those known in the art that provide a connection 301. After transfer of the pass code 304 to the client system 110, the pass code 304 may be stored in the memory 302 of client system 110 consistent with the description herein. As an example, it may be stored in a client application 112.

Once the pass code 304 is resident on the client system 110, the client system 110 may then be physically brought in proximity to the access point 130 and connected via a local connection 122. As described herein, local connection 122 is only effective within a limited range. The local connection 122 may also be a low power protocol in addition to having a limited range. For example, BlueTooth® may be a protocol used to transfer data. LoRa® may be a protocol used to transfer data. NFC Logical Link Control Protocol (LLCP) may also be used. As yet another alternative, any protocol compliant with IEEE 802.2 may be used. For certain embodiments discussed herein, a single direction data flow may be sufficient. For other embodiments, a bidirectional data flow standard may be desirable. Other low power and low distance of transmission protocols may be used in the alternative or in addition to one of the above protocols.

Using one of the above described communication protocols, the client system 110 transmits the pass code 304 to the access point 130. The pass code 304 is then compared against pass code 308, which is the same code but already provided to the entry control system 132. As an example, pass code 308 may be stored in a memory provided on the access point 130. Alternatively, pass code 308 may be a pseudorandom code that is generated based on a variety of known methods such as hashing with a variable such as time. In such an instance, pass code 304 will likewise be generated on the client system 110 to provide the correct matching code. Pass code 308 may also be a hard wired or embedded code assigned to a specific access point 130, which is part of a specific entry control system 132.

Assuming that the access point 130 compares pass code 304 and pass code 308 and verifies that they are the same, it then grants access to the user. In particular, the access point 130 may unlock the gate 136 via triggering the locking mechanism 134.

Referring still to FIG. 3, the exemplary system may, in some embodiment, utilize multiple auxiliary pass codes in addition to or in replacement of the pass codes 304, 308 discussed above.

In another embodiment illustrated in FIG. 3, primary auxiliary codes 310 and 312 may be used in addition to pass codes 304 and 308. In particular, primary auxiliary codes 310 and 312 may be additional information previously provided to the entry control system 132 that acts to provide additional verification (i.e., verification codes) that a user providing pass code 304 to the entry control system 132 is an authorized user. As an example, a primary auxiliary code 310 may be a specific code associated with a specific access point 130, e.g., a serial number, that provides an additional layer of security when employed.

In another embodiment illustrated in FIG. 3, secondary auxiliary codes 314 and 316 may be yet another set of codes used to provide additional security to the system. In this embodiment, entry control system 132 includes memory 306 capable of storing and retrieving more than one code in memory 306. The secondary auxiliary code 316 may be a predefined code that is part of a list known to the remote access management system 102. Once prior authorized users are provided with the pass code 304 and the primary auxiliary code 310 (which corresponding pass code 308 and primary auxiliary code 312), the remote access management system 102 will assign the next authorized user a next assigned code from the list stored in memory 306, e.g., secondary auxiliary code 316. In this manner, it is possible to have a plurality of predetermined codes available to assign to users to the extent that the memory 306 may hold additional codes.

In yet another embodiment illustrated in FIG. 3, tertiary auxiliary codes 318 and 320 may provide yet another additional layer of security. Like one of the proceeding embodiments, it is assumed for this embodiment that entry control system 132 includes memory 306 that is capable of storing and retrieving a code. In addition, the memory 306 as described in this embodiment is further capable of writing a code as tertiary auxiliary code 320 into memory 306. In this embodiment, it is assumed that a prior user received at least the pass code 304 and the tertiary auxiliary code 318. It is further assumed that upon authorization using only the pass code 304, that the tertiary auxiliary code 318 is also transferred to the entry control system 132 and stored in memory 306 as tertiary auxiliary code 320. The next instance where the remote access management system 102 issues a code for an authorized user, it then issues the tertiary auxiliary code 318 which is the corresponding code to the previously stored tertiary auxiliary code 320. As such, as described in this embodiment it is possible to dynamically generate a code in advance (e.g., tertiary auxiliary code 318), have a user transfer the code generated in advance, and have the code pre-stored in memory 306 for use by a subsequent user. Although the system in FIG. 3 only illustrates three auxiliary codes, the number of auxiliary pass codes is not limited and can be expanded up to the capacity of the memory 306 of the entry control system 132.

In yet another embodiment illustrated in FIG. 3, special use, or temporary, codes 322, 324 may be generated by the remote access management system 102 for a special use case. As an example, if vendor or service personal are to be authorized access to only part of a specific secured area 140, then a temporary code 322 may be generated and matched to temporary code 324 by the entry control system 132. It will now be apparent to one of ordinary skill in the art that a number of variations of special use, or temporary, codes may be possible. For instance, if the entry control system 132 further includes an internal clock, special use codes 322, 324 may only be authorized to provide access between a certain predetermined time interval. Temporary codes 322, 324 may also be provided and rewritten on a periodic (e.g., daily) basis to facilitate vendor or service access.

It will also now be apparent to one of ordinary skill that the above described embodiments are not necessarily exclusive and may be used in different combinations with each other without varying from the scope of embodiments described herein. For example, in the case of a bidirectional data flow, it would also be possible for the entry control system 132 to transmit messages via other codes to the user (e.g., via the client system 110), who will then relay those codes back to the remote access management system 102 when the client system 110 again connects with the network 120. As an example, the entry control system 132 could transmit a low battery warning to the remote access management system 102, which could, in turn provide, a notice to an administrator of the remote access management system 102 that the low battery warning was transmitted from a client system 110 that had been brought into proximity with a particular access point of the entry control system 132. In addition or in the alternative, the entry control system 132 could also upload a log of activity on the entry control system 132 to a client system 110 brought into proximity with the entry control system 132. Like the variation discussed above, these logs could then be sent back to the remote access management system 102 via the client system 110 once the client system 110 is able to connect with the network 120. Other similar status information about the entry control system 132 can likewise be sent from the entry control system 132 to the remote access management system 102.

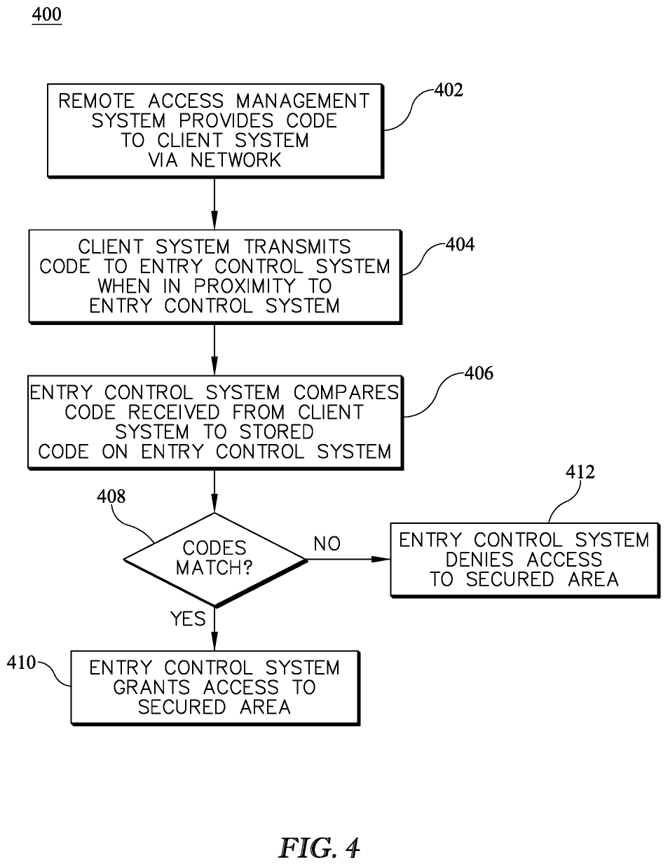

Further discussion of a method consistent with the above described systems and apparatuses is illustrated in FIG. 4. The method 400 shown in FIG. 4 illustrates one exemplary implementation of the embodiments described above. Method 400 begins with block 402 in which the remote access management system 102 provides a code to a client system 110 via the network 120. As is already discussed above, the network 120 may be any of a variety of network systems capable of connecting to the client system 110. The connection between the client system 110 and the network 120 may be accomplished by any of a variety of conventional systems.

Once the code has been loaded onto the client system 110, the next step is illustrated as block 404 in which the client system 110 transmits the code present on the client system 110 to an entry control system 132. This occurs when the client system 110 is brought into proximity with the entry control system 132. As already highlighted above, communication between the client system 110 and the entry control system 132 is accomplished by a protocol capable of transmitting over limited distances. As an example, a near field communication protocol might be used. Other protocols requiring close proximity to the receiver may also be used. In addition, a low power protocol may be used to minimize the energy required by the entry control system 132.

The method then proceeds to block 406, in which the entry control system 132 compares the code received from the client system 110 to a stored code on the entry control system 132. As an example, the entry control system 132 may compare pass code 304 to pass code 308 as illustrated in FIG. 3. As illustrated by comparator 408, the entry control system 132 then compares these codes. If the codes match, the system proceeds to block 410 in which the entry control system 132 grants access to the secured area 140 illustrated in FIG. 1. With reference to FIGS. 1 and 3, the entry control system 132, which is in communication with a locking mechanism 134, will trigger the locking mechanism 134 and free a lock securing barrier 136. The authorized user is then granted access to secured area 140. In contrast, if the codes do not match, the system proceeds to block 412 in which the entry control system 132 denies access to the secured area 140.

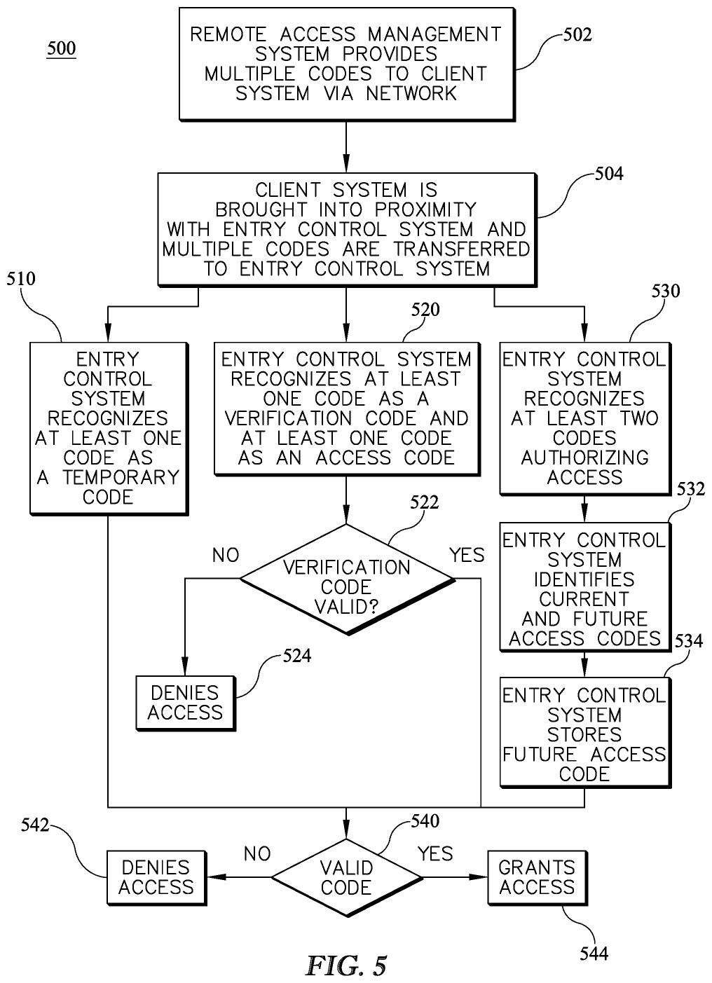

FIG. 5 illustrates method 500 that includes variations of the different embodiments discussed above. Method 500 begins with block 502 in which the remote access management system 102 provides multiple codes to the client system 110 via the network 120. Examples of the multiple codes are illustrated in FIG. 3, and may include codes 304, 308, 310, 312, 314, 316, 318, 320, 322, and 324. As will be discussed in more detail below, these codes may be transparent to the user. Certain codes, however, may not be transparent and may be stored on the client system 110, but are hidden, or inaccessible, to the user.

Proceeding to block 504, the client system 110 is then brought in proximity with the entry control system 132. The multiple codes are then transferred to the entry control system 132 once the client system 110 and the entry control system 132 are in communication.

With reference to some exemplary implementations of the embodiments discussed above, block 510 illustrates when the entry control system 132 recognizes that there is at least one code provided of the multitude of codes as a temporary code. These temporary codes may be issued, for example, to a vendor. Alternatively, the temporary code may be a code indicating a new user.

With reference to some other exemplary implementations of the embodiments discussed above, block 520 illustrates when the entry control system 132 recognizes at least one of the codes as a verification code. As discussed above, verification codes may be used to provide an additional level of security. As also illustrated in block 520, at least one of the multiple codes transferred to the entry control system 132 is also recognized as an access code. As used with respect to this embodiment, an access code is a code associated with an authorized user. As there may be multiple authorized users, the multiple codes transferred to the entry control system 132 may include multiple additional codes that are each associated with one of the multiple authorized users.

As illustrated in block 522, the verification code is then checked against verification codes stored on the entry control system 132. If the verification code is not found to be valid, access is denied as shown in block 524.

With reference to still other exemplary implementations of the embodiments discussed above, block 530 illustrates when the entry control system 132 recognizes at least two codes as authorizing access to the secured area. As discussed further below, one of the authorizing codes may not be transparent to the user, i.e., may be hidden from the user in a nontransparent portion of the application. If such a code is detected, as shown in block 532, the entry control system 132 identifies the current and future access code. As shown in block 534, the future access code is then stored on the entry control system 132 for future access by a future user. The future access code may be stored on the client system 110, but may not be transparent to the user.

For each of the embodiments discussed above, eventually comparator block 540 is reached. At comparator block 540, the entry control system 132 compares the codes provided by the client system 110 against valid codes stored in the entry control system 132. Assuming that a valid code has been provided by the user, the system grants access to the secured area that is illustrated in block 544. If a valid code has not been demonstrated by the user, then access is denied as shown in block 542.

FIG. 6 is a block diagram of an exemplary computer system 600 that can be used for implementing exemplary embodiments of the present invention. Computer system 600 includes one or more processors, such as processor 604. Processor 604 is connected to a communication infrastructure 602 (for example, a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

Exemplary computer system 600 can include a display interface 608 that forwards graphics, text, and other data from the communication infrastructure 602 (or from a frame buffer not shown) for display on a display unit 610. Computer system 600 also includes a main memory 606, which can be random access memory (RAM), and may also include a secondary memory 612. Secondary memory 612 may include, for example, a hard disk drive 614 and/or a removable storage drive 616, representing a floppy disk drive, a magnetic tape drive, an optical disk drive, etc. Removable storage drive 616 reads from and/or writes to a removable storage unit 618 in a manner well known to those having ordinary skill in the art. Removable storage unit 618, represents, for example, a floppy disk, magnetic tape, optical disk, etc. which is read by and written to by removable storage drive 616. As will be appreciated, removable storage unit 618 includes a computer usable storage medium having stored therein computer software and/or data.

In exemplary embodiments, secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (that is, channel) 626. Channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It can be used, for example, to transport information, such as data and computer instructions, between computer systems. Furthermore, the computer readable medium may comprise computer readable information in a transitory state medium such as a network link and/or a network interface including a wired network or a wireless network that allow a computer to read such computer readable information.

Computer programs (also called computer control logic) are stored in main memory 606 and/or secondary memory 612. Computer programs may also be received via communications interface 624. Such computer programs, when executed, can enable the computer system to perform the features of exemplary embodiments of the present invention as discussed herein. In particular, the computer programs, when executed, enable processor 604 to perform the features of computer system 600. Accordingly, such computer programs represent controllers of the computer system.

Aspects of exemplary embodiments of the present invention described herein can be implemented using one or more program modules and data storage units. As used herein, the term “modules”, “program modules”, “components”, “systems”, “tools”, “utilities”, and the like include routines, programs, objects, components, data structures, and instructions, or instructions sets, and so forth that perform particular tasks or implement particular abstract data types. As can be appreciated, the modules refer to computer-related entities that can be implemented as software, hardware, firmware and/or other suitable components that provide the described functionality, and which may be loaded into memory of a machine embodying an exemplary embodiment of the present invention. Aspects of the modules may be written in a variety of programming languages, such as C, C++, Java, etc. The functionality provided by modules used for aspects of exemplary embodiments described herein can be combined and/or further partitioned.

As used herein, the terms “data storage unit,” “data store”, “storage unit”, and the like can refer to any suitable memory device that may be used for storing data, including manual files, machine readable files, and databases. The modules and/or storage units can all be implemented and run on the same computing system (for example, the exemplary computer system illustrated and described below) or they can be implemented and run on different computing systems. For example, one or modules can be implemented on a personal computer operated by a user while other modules can be implemented on a remote server and accessed via a network.

In exemplary embodiments, the client applications utilized in exemplary embodiments of the present invention can be configured for incorporation within any suitable network computing environment as a plug-in, add-on, or extension. As used herein, the term “plug-in” can refer to a software application or module program, or one or more computer instructions, which may or may not be in communication with other software applications or modules, that interacts with a host application to provide specified functionality, and which may include any file, image, graphic, icon, audio, video, or any other attachment. In other exemplary embodiments, the client applications can be implemented as a standalone program that is run as a separate computer process, a portable application, a native component of a software tool, a part of a software bundle, or any other suitable implementation.

In the preceding description, for purposes of explanation, numerous specific details are set forth in order to provide a thorough understanding of the described exemplary embodiments. Nevertheless, one skilled in the art will appreciate that many other embodiments may be practiced without these specific details and structural, logical, and electrical changes may be made.

Some portions of the exemplary embodiments described above are presented in terms of algorithms and symbolic representations of operations on data bits within a processor-based system. The operations are those requiring physical manipulations of physical quantities. These quantities may take the form of electrical, magnetic, optical, or other physical signals capable of being stored, transferred, combined, compared, and otherwise manipulated, and are referred to, principally for reasons of common usage, as bits, values, elements, symbols, characters, terms, numbers, or the like. Nevertheless, it should be noted that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

Exemplary embodiments of the present invention can be realized in hardware, software, or a combination of hardware and software. Exemplary embodiments can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

Exemplary embodiments of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following: (a) conversion to another language, code or, notation; and (b) reproduction in a different material form.

A computer system in which exemplary embodiments can be implemented may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

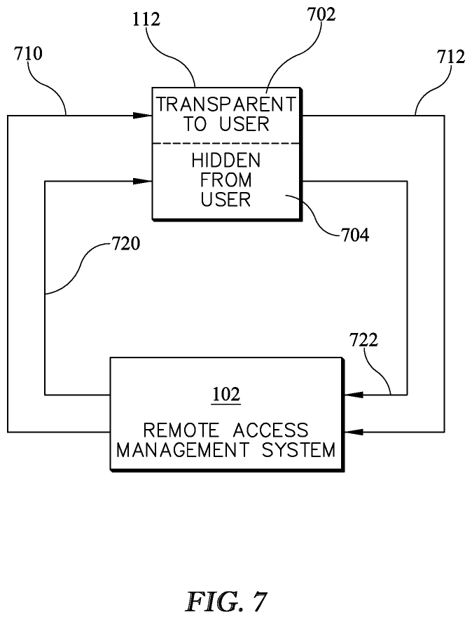

FIG. 7 illustrates one exemplary client application 112 interacting with the remote access management system 102 in more detail. In at least one embodiment, the client application 112 will have a transparent section 702 and a hidden section 704. Transparent section 702 and hidden section 704 may each function as a virtual computer. In other words, each of the sections 702, 704 will function as a virtual computer including virtual memory, virtual IO, and a virtual processor, that allows these sections to act independently.

The transparent section 702 will receive certain data from the remote access management system 102 via data channel 710, and may output data through data channel 712 to remote access management system 102. Transparent section 702 may be used to manage information that is required by the user or system but is transparent to the user. As an example, transparent section 702 can be configured to provide receipts that are provided by the remote access management system 102 when a new user is authorized. Other examples of this type of user data required for the operation of the systems and methods described herein will now be apparent to one of ordinary skill in the art. As an example, other functionality may be provided by the inclusion of the transparent section 702 such as the ability to do a temporary code request. For a temporary code request, a user may interact with the virtual system of the transparent section 702, e.g., through a graphically user interface that allows the user to request the temporary code. After requesting the temporary code, this request is forwarded via data channel 712 to the remote access management system 102 which processes the request for the temporary code. If the user is authorized to issue such a code, the remote access management system 102 will then transmit the temporary code via data channel 710. It will now be apparent to one of ordinary skill in the art that the graphical user interface described with respect to transparent section 702 can also be provided with additional contact information, i.e., the contact information for the person intended to receive the temporary code. As such, a user can request a temporary code, have the remote access management system 102 authorize the code, and then have the remote access management system 102 transmit the code to the user, as well as the person intended to receive the temporary code. Other functionality will now also be apparent to one of ordinary skill in the art based on the above described embodiments.

The hidden section 704 may also function as a virtual computer as already described above. However, the hidden section 704 may be configured to interact solely with the remote access management system 102. As an example, the remote access management system 102 may wish to gather log information from an entry control system 132. For example, when a client system 110 is brought into proximity with an entry control system 132, the entry control system 132 may be pre-programmed to transfer stored data onto the client system 110. In this specific example, the entry control system 132 will have maintained a record of all entry access information associated with the specific system 132. As the user passes to transmit the code or even comes into proximity with the entry control system 132, the entry control system 132 may trigger a data transfer to the client system 110 that will ultimately be supplied to the remote access management system 102 when the user reconnects to the network 120. This logged information is not relevant to the user, but provides the system owner of the remote access management system 102 with additional information that is desirable. As such, this information may be stored in the hidden section 704 that is not transparent to the user. After the data has been uploaded into the hidden section 704, it can be transmitted via data path 722 to the remote access management system 102.

The remote access management system 102 may also transmit other information via data channel 720 to an entry control system 132 via a client system 110. As an example, the remote access management system 102 may wish to provide an update to one entry control system 132. Such data may be piggybacked onto the client system 110.

Other examples of upstream and downstream data transfer between the remote access management system 102 and entry control systems 132 via the client systems 110 and the application there 112, will now be obvious to one of ordinary skill in the art. As an example, an entry control system 132 may conduct some form self-monitoring. As a further example of this, battery levels for a remote station may be critical to the ongoing operation of the entry control system 132. If a battery begins to display erratic behavior or other undesirable behavior with respect to maintaining a charge, for example, the entry control system 132 may indicate this via a code uploaded into the hidden section 704 on the client system 110. This code may then be transmitted via data path 712 to the remote access management system 102. Upon receipt, the remote access management system 102 may then produce an alert to dispatch a technician to perform maintenance on a battery attached to the entry control system 132.

It will also now be apparent to one of ordinary skill in the art that the data handled by the transparent section 702 and the hidden section 704 may be handled differently by the system. For example, data transmitted between the hidden section 704 and the remote access management system 102 may be encrypted to ensure system integrity. In certain instances, it may also be desirable to encrypt the data transmitted between the client application 112 and the remote access management system 102.

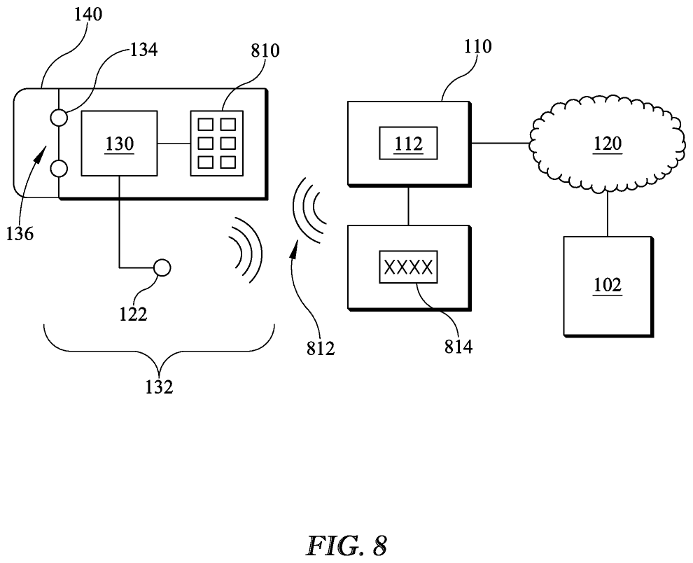

Now referring to FIG. 8, an embodiment consistent with the methods and operations discussed above includes a network 120, a system 102, a client system 110, and an entry control system 132 including a local connection 122. An application 112 may be present on the client system 110. A keypad code 814 may be stored on the client system 110. Alternatively, the keypad code 814 may be stored in the application 112 resident on client system 110. As is described above, codes are transmitted from the system 102 via the network 120 to the client system 110. As will now be apparent to one of ordinary skill in the art, any code transmitted to the client system 110 may be stored in the client system 110. In at least one embodiment, the code may be stored in the application 112 resident on the client system 110.

The entry control system 132 in FIG. 8 further includes a keypad 810. The keypad 810 may be used by an authorized user to enter the secured area 140 via the entry control system 132. When the correct code is physically entered on keypad 810, it triggers the entry control system 132 to allow access to the secure area 140. As an example, when a code 814 present in the client system 110 is entered on keypad 810, the entry control system 132 unlocks the locking mechanism 134 to allow access of the user to the secured area 140.

In the embodiment described here, the code 814 transmitted to the entry control system 132 is a code for the keypad 810. As will now be obvious based on the description of the methods and apparatus discussed above, upon receipt of the code 814 and verification by the entry control system 132, the entry control system 132 may update authorized codes in the system to include code 814. After the entry control system 132 has updated, this will allow a user to enter the code 814 physically on keypad 810 and receive access to secured area 140.

It will now also be apparent that this code may be updated using any other variety of methods discussed above. The capture and verification of the code provided for the keypad 810 may be provided to the entry control system 132 using one or more of the methods described above.

Moreover, it will now be apparent that the code 814 does not necessarily need to be associated with the user that brings the client system 110 into proximity with the entry control system 132. Instead, the code 814 may piggy back on another client system 110, be transmitted to the entry control system 132 to update valid codes for entry via keypad 810 in a manner completely hidden from the user of the client system 110. It will also be apparent that the code 814 may be transparent to the user. For example, the code 814 may be displayed on the client system 110 to facilitate the user's entry of the code into keypad 810. Likewise, temporary codes may also be displayed on the client system 110 should an authorized provider of code or a previously authorized user request that a code by provided to a temporary user.

While the invention has been described in detail with reference to exemplary embodiments, it will be understood by those skilled in the art that various changes and alternations may be made and equivalents may be substituted for elements thereof without departing from the scope of the invention as defined by the appended claims. In addition, many modifications may be made to adapt a particular application or material to the teachings of the invention without departing from the essential scope thereof.

Variations described for exemplary embodiments of the present invention can be realized in any combination desirable for each particular application. Thus particular limitations, and/or embodiment enhancements described herein, which may have particular limitations need be implemented in methods, systems, and/or apparatuses including one or more concepts describe with relation to exemplary embodiments of the present invention.

Therefore, it is intended that the invention not be limited to the particular embodiments disclosed herein for carrying out this invention, but that the invention will include all embodiments falling within the scope of the present application as set forth in the following claims, wherein reference to an element in the singular, such as by use of the article “a” or “an” is not intended to mean “one and only one” unless specifically so stated, but rather “one or more.” Moreover, no claim element is to be construed under the provisions of 35 U.S.C. § 112, sixth paragraph, unless the element is expressly recited using the phrase “means for” or “step for.” These following claims should be construed to maintain the proper protection for the present invention.

What is claimed is:

1. A method for managing and controlling access to secured areas, the method comprising:
providing a first code to a client system via a network, the first code being stored in an application resident on the client system;
capturing the first code from the client system when the client system is brought into proximity of an entry control system via a local connection to the entry control system;
comparing the first code with a second code, the second code being a predetermined code previously provided to the entry control system; and
granting access to a secured area if the first code and second code match.

2. The method for managing and controlling access to secured areas according to claim 1, wherein the client system is provided multiple additional codes and each of the multiple additional codes are captured from the client system when the client system is brought into proximity of the entry control system.

3. The method for managing and controlling access to secured areas according to claim 2, wherein the multiple additional codes are captured from the client system if the first code and second code match.

4. The method for managing and controlling access to secured areas according to claim 2, wherein the first and second codes are associated with a first authorized user and one of the multiple additional codes is associated with a second authorized user.

5. The method for managing and controlling access to secured areas according to claim 2, wherein the entry control system is previously provided with a list of predetermined codes that correspond to the multiple additional codes.

6. The method for managing and controlling access to secured areas according to claim 2, wherein one of the multiple additional codes is a first verification code which is compared to a second verification code previously provided to the entry control system, and wherein access is granted to the secured area if both (1) the first code and second code match and (2) the first verification code and the second verification code match.

7. The method for managing and controlling access to secured areas according to claim 6, wherein the first and second codes are associated with one of multiple authorized users and the first and second verification codes are associated with one of multiple entry control systems.

8. The method for managing and controlling access to secured areas according to claim 1, wherein the first code, the second code, or both the first code and the second code include information about a predetermined time interval in which to grant access to the secured area and access is granted to the secured area if (1) the first code and second code match and (2) the first code is captured during the predetermined time internal.

9. The method for managing and controlling access to secured areas according to claim 1, wherein the client system is additionally provided a future access code and the future access code is captured from the client system when the client system is brought into proximity of the entry control system, and wherein the method further comprising:
providing an access code to a second client system via the network, the access code being stored in an application resident on the second client system;
capturing the access code from the second client system when the second client system is brought into proximity of the entry control system via the local connection to the entry control system;
comparing the access code with the future access code previously provided to the entry control system; and
granting access to the secured area if the access code and future access code match.

10. The method for managing and controlling access to secured areas according to claim 1, wherein the first code is a pseudorandom code generated on the client system and wherein the second code is a pseudorandom code generated on the entry control system.

11. The method for managing and controlling access to secured areas according to claim 1, wherein the second code is a hard wired to the entry control system.

12. The method for managing and controlling access to secured areas according to claim 1, wherein the local connection provides for bidirectional data flow between the client system and the entry control system, the method further comprising capturing status information about the entry control system from the entry control system when the client system is brought into proximity of the entry control system via the local connection.

13. The method for managing and controlling access to secured areas according to claim 1, the method further comprising establishing a connection between the client system and a remote access management system via the network, the remote access management system providing the first code to the client system.

14. The method for managing and controlling access to secured areas according to claim 13, wherein the local connection provides for bidirectional data flow between the client system and the entry control system, the method further comprising capturing status information about the entry control system from the entry control system when the client system is brought into proximity of the entry control system via the local connection and providing the status information to the remote access management system.

15. A method for updating a keypad code for an entry control system, the method comprising:
providing a first code to a client system via a network;
capturing the first code from the client system when the client system is brought into proximity of an entry control system via a local connection to the entry control system;
comparing the first code with a second code, the second code being a predetermined code previously provided to the entry control system; and
updating a keypad code associated with an authorized user for a keypad provided in communication with the entry control system,
wherein, when the keypad code is entered on the keypad, the entry control system grants access to a secured area.

16. The method for updating a keypad code for an entry control system according to claim 15, the method further comprising an application resident on the client system, wherein the first code is stored in the application.

17. The method for updating a keypad code for an entry control system according to claim 15, the method further comprising verifying the keypad code based on a predetermined code stored on the entry control system and updating the keypad code if verified.

18. A system for managing and controlling access to secured areas, the system comprising:
a remote access management system including a data store and a server operably coupled to a network, the data store including multiple codes each associated with a corresponding secured area;
multiple entry control systems including memory, each entry control system in communication with a locking mechanism at a corresponding secured area;
multiple portable client systems including a client application configured to receive and output data, each of the client systems configured to connect to the remote access management system via the network, each of the client systems configured to connect to at least one of the multiple entry control systems via a local connection to the entry control system when the client system is brought into proximity of the entry control system;
wherein, the server of the remote access management system is configured to transfer one or more of the multiple codes included in the data store to the client application of the multiple portable client systems via the network, and
wherein each of the multiple entry control systems is configured to (1) capture a first code from the client application of one of the multiple portable client systems via the local connecton when the client system is brought into proximity of the entry control system; (2) compare the first code with a second code, the second code being a predetermined code previously stored in the memory to the entry control system; and (3) grant access to the secured area if the first code and second code match.

19. The system for managing and controlling access to secured areas of claim 18, wherein at least one of the multiple entry control systems further comprising a keypad in communication with the locking mechanism;
wherein the at least one of the multiple entry control systems is configured to update a keypad code for the keypad if the first code and second code match, such that, when the keypad code is entered on the keypad, the entry control system grants access to a secured area.

20. The system for managing and controlling access to secured areas of claim 18, wherein the local connection provides for bidirectional data flow between the client application of one of the multiple portable client systems when the client system is brought into proximity of the entry control system, and wherein the entry control system is configured to transfer status information about the entry control system to the client application of the multiple portable client system via the local connection such that the remote access management system can access the status information about the entry control system via the network.
